(19) United States
(12) Patent Application Publication
(10) Pub. No.: US 2026/0155932 A1
(43) Pub. Date: Jun. 4, 2026

(54) METHODS AND APPARATUSES FOR CSI REPORTING

(71) Applicant: LENOVO (BEIJING) LIMITED, Beijing (CN)

(72) Inventors: Yi Zhang, Beijing (CN); Chenxi Zhu, Beijing (CN); Wei Ling, Beijing (CN); Bingchao Liu, Beijing (CN); Lingling Xiao, Beijing (CN)

(21) Appl. No.: 19/111,356

(22) PCT Filed: Sep. 28, 2022
(86) PCT No.: PCT/CN2022/122128

§ 371 Date: Mar. 13, 2025

(51) Int. Cl. H04L 5/00; H04B 7/06; H04W 24/10

(52) U.S. Cl. CPC H04L 5/0051; H04B 7/0626; H04W 24/10

(57) ABSTRACT

The present application relates to methods and apparatuses for channel state information (CSI) reporting. An embodiment of the present disclosure provides a user equipment (UE), comprising: a transceiver that: receives a codebook configuration for CSI reporting associated with a plurality of channel state information reference signal (CSI-RS) resources; and transmits a CSI report based on the codebook configuration; and a processor that is coupled with the transceiver.

### TECHNICAL FIELD

The present disclosure relates to wireless communications, and particularly relates to methods and apparatuses for channel state information (CSI) reporting.

### BACKGROUND OF THE INVENTION

The continuing evolution of multiple input multiple output (MIMO) may be the most important part of 3^{rd} generation partnership project (3GPP) physical layer. It is important to identify and specify necessary enhancements for both downlink and uplink MIMO for facilitating the use of large antenna array, not only for frequency range 1 (FR1) but also for FR2 to fulfil the request for evolution of new radio (NR) deployments in Rel-18.

As coherent joint transmission (CJT) improves coverage and average throughput in commercial deployments with high-performance backhaul and synchronization, enhancements on CSI acquisition for frequency division duplex (FDD) and time division duplex (TDD), targeting FR1, can be beneficial in expanding the utility of multiple transmission or reception points (TRPs) deployments.

Therefore, it is advantageous to provide methods and apparatuses for CSI reporting in CJT scenarios.

### SUMMARY

An embodiment of the present disclosure provides a user equipment (UE), comprising: a transceiver that: receives a codebook configuration for CSI reporting associated with a plurality of channel state information reference signal (CSI-RS) resources; and transmits a CSI report based on the codebook configuration; and a processor that is coupled with the transceiver.

In some embodiments, the codebook configuration includes at least one first parameter, and each first parameter indicates a codebook subset restriction for a number pair consisting of: a first number of antenna ports in a first dimension; and a second number of antenna ports in a second dimension; wherein each of the at least one first parameter is associated with one of the plurality of CSI-RS resources; or wherein in the case that only one first parameter is included in the codebook configuration, the first parameter is associated with the plurality of CSI-RS resources.

In some embodiments, restricted values of the first number and the second number included in the codebook subset restriction are determined based on a total number of the plurality of CSI-RS resources, a capability of the UE, or both.

In some embodiments, the transceiver further transmits a capability of the UE to a base station (BS), wherein the capability of the UE includes one of the following: a supported maximum number of CSI-RS resources as channel measurement resources and a supported maximum number of CSI-RS ports per CSI-RS resource; the supported maximum number of CSI-RS resources as channel measurement resources and a supported maximum number of CSI-RS ports across CSI-RS resources; or the supported maximum number of CSI-RS ports across CSI-RS resources.

In some embodiments, the supported maximum number of CSI-RS ports across CSI-RS resources includes a value selected from a set including at least one of 8, 12, 16, 24, 32, or 64.

In some embodiments, the codebook configuration further indicates a same pair of values of the number pair for each of the plurality of CSI-RS resources.

In some embodiments, the codebook configuration includes at least one second parameter, and each second parameter indicates a combination consisting of: a number of selected beams L; a factor β; and a frequency compression ratio p_{ν}; wherein each of the at least one second parameter is associated with one of the plurality of CSI-RS resources; or wherein in the case that only one second parameter is included in the codebook configuration, the second parameter is associated with the plurality of CSI-RS resources.

In some embodiments, the number of selected beams is 2 or 4 in the case that the number of selected beams is configured per CSI-RS resource, or is 4, 5, 6, 7, or 8 in the case that the number of selected beams is configured across the plurality of CSI-RS resources.

In some embodiments, the factor is a value smaller than ¼ in the case that more than two CSI-RS resources are included in the plurality of CSI-RS resources.

In some embodiments, the CSI report includes a number of non-zero coefficients, and the processor determines at least one of the following based on the codebook configuration: a maximum number of non-zero coefficients per layer per CSI-RS resource; a maximum number of non-zero coefficients across layers per CSI-RS resource; a maximum number of non-zero coefficients per layer across CSI-RS resources; or a maximum number of non-zero coefficients across layers across CSI-RS resources.

In some embodiments, in the case that a factor β, a number of selected beams L, and a number of bases in a frequency domain M₁ are configured per CSI-RS resource in the codebook configuration, the maximum number of non-zero coefficients per layer per CSI-RS resource is determined to be K₀=┌β2LM₁┐, and the maximum number of non-zero coefficients across layers per CSI-RS resource is determined to be 2K₀.

In some embodiments, in the case that a factor, a number of selected beams L, and a number of bases in a frequency domain M₁ are configured across CSI-RS resources in the codebook configuration, the maximum number of non-zero coefficients per layer per CSI-RS resource is determined to be K₀=┌β2LM₁/N┐, and the maximum number of non-zero coefficients across layers per CSI-RS resource is determined to be 2K₀, wherein N is a total number of the plurality of CSI-RS resources.

In some embodiments, in the case that a factor β, a number of selected beams L, and a number of bases in a frequency domain M₁ are configured per CSI-RS resource in the codebook configuration, for each CSI-RS resource, the processor determines a value K₀=┌β2LM₁┐, the maximum number of non-zero coefficients per layer across CSI-RS resources is determined to be

$$x\_k1 \times {K}_{0}^{′} ,$$

and the maximum number of non-zero coefficients across layers across CSI-RS resources is determined to be 2x_k1×K₀, wherein x_k1 is a predefined coefficient or a configured coefficient, and

$${K}_{0}^{′}$$

is a maximum of an average of an the determined values K₀.

In some embodiments, in the case that a factor β, a number of selected beams L, and a number of bases in a frequency domain M₁ are configured across CSI-RS resources in the codebook configuration, the maximum number of non-zero coefficients per layer across CSI-RS resources is determined to be K₀=┌β2LM₁┐, and the maximum number of non-zero coefficients across layers across CSI-RS resources is determined to be 2K₀.

In some embodiments, the codebook configuration further indicates a same rank restriction for each of the plurality of CSI-RS resources.

Another embodiment of the present disclosure provides a BS, comprising: a transceiver that: transmits a codebook configuration for CSI reporting associated with a plurality of CSI-RS resources; and receives a CSI report based on the codebook configuration; and a processor that is coupled with the transceiver.

In some embodiments, the codebook configuration includes at least one first parameter, and each first parameter indicates a codebook subset restriction for a number pair consisting of: a first number of antenna ports in a first dimension; and a second number of antenna ports in a second dimension; wherein each of the at least one first parameter is associated with one of the plurality of CSI-RS resources; or wherein in the case that only one first parameter is included in the codebook configuration, the first parameter is associated with the plurality of CSI-RS resources.

In some embodiments, restricted values of the first number and the second number included in the codebook subset restriction are determined based on a total number of the plurality of CSI-RS resources, a capability of a UE, or both.

In some embodiments, the transceiver further receives a capability of the UE from the UE, wherein the capability of the UE includes one of the following: a supported maximum number of CSI-RS resources as channel measurement resources and a supported maximum number of CSI-RS ports per CSI-RS resource; the supported maximum number of CSI-RS resources as channel measurement resources and a supported maximum number of CSI-RS ports across CSI-RS resources; or the supported maximum number of CSI-RS ports across CSI-RS resources.

In some embodiments, the supported maximum number of CSI-RS ports across CSI-RS resources includes a value selected from a set including at least one of 8, 12, 16, 24, 32, or 64.

In some embodiments, the codebook configuration further indicates a same pair of values of the number pair for each of the plurality of CSI-RS resources.

In some embodiments, the codebook configuration includes at least one second parameter, and each second parameter indicates a combination consisting of: a number of selected beams L; a factor β; and a frequency compression ratio p_{ν}; wherein each of the at least one second parameter is associated with one of the plurality of CSI-RS resources; or wherein in the case that only one second parameter is included in the codebook configuration, the second parameter is associated with the plurality of CSI-RS resources.

In some embodiments, the number of selected beams is 2 or 4 in the case that the number of selected beams is configured per CSI-RS resource, or is 4, 5, 6, 7, or 8 in the case that the number of selected beams is configured across the plurality of CSI-RS resources.

In some embodiments, the factor is a value smaller than ¼ in the case that more than two CSI-RS resources are included in the plurality of CSI-RS resources.

In some embodiments, the codebook configuration further indicates a same rank restriction for each of the plurality of CSI-RS resources.

Yet another embodiment of the present disclosure provides a method performed by a UE, comprising: receiving a codebook configuration for CSI reporting associated with a plurality of CSI-RS resources; and transmitting a CSI report based on the codebook configuration.

Still another embodiment of the present disclosure provides a method performed by a BS, comprising: transmitting a codebook configuration for CSI reporting associated with a plurality of CSI-RS resources; and receiving a CSI report based on the codebook configuration.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of an exemplary wireless communication system according to some embodiments of the present disclosure.

FIG. 2 illustrates a flowchart of an exemplary method performed by a UE for CSI reporting according to some embodiments of the present disclosure.

FIG. 3 illustrates a flowchart of an exemplary method performed by a BS for CSI reporting according to some embodiments of the present disclosure.

FIG. 4 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results: sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3GPP long term evolution (LTE), LTE-Advanced (LTE-A), 3GPP 4G, 3GPP 5G NR, 3GPP Release 16 and onwards, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

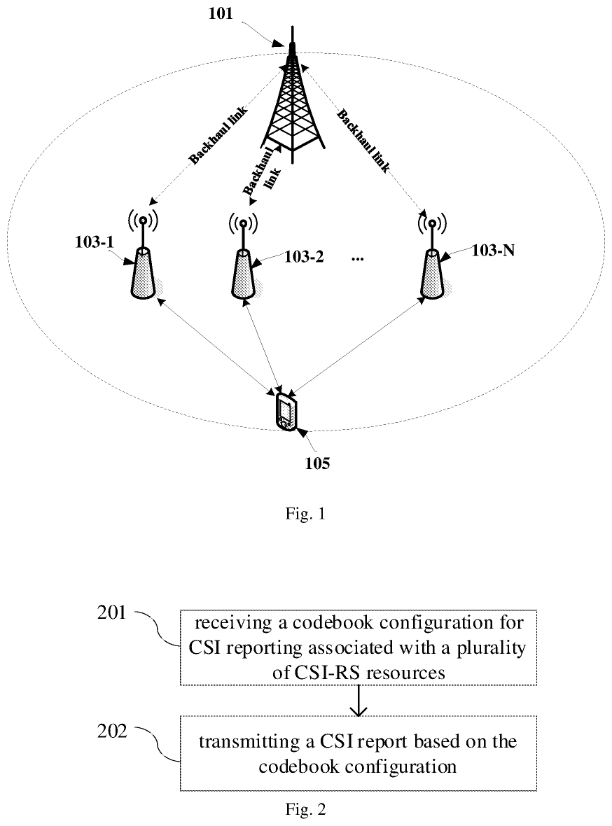

FIG. 1 is a schematic diagram illustrating an exemplary wireless communication system according to some embodiments of the present application.

Referring to FIG. 1, the wireless communication system may include a BS 101, a number of TRPs (e.g., TRP 103-1, TRP 103-2, . . . , TRP 103-N), and a UE 105. Although only one BS 101, three TRPs and one UE 105 are shown for simplicity, it should be noted that the wireless communication system may include more or less communication device(s), apparatuses, or node(s) in accordance with some other embodiments of the present application.

The wireless communication system is compatible with any type of network that is capable of sending and receiving wireless communication signals. For example, the wireless communication system is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

The TRPs can communicate with the BS 101 via, for example, a backhaul link. Each of the TRPs can serve one or more UEs. As shown in FIG. 1, the TRP 103-1 can serve some mobile stations (which include the UE 105) within a serving area or region (e.g., a cell or a cell sector), the TRP 103-2 can serve some mobile stations (which include the UE 105) within a serving area or region (e.g., a cell or a cell sector), and the TRP 103-N can serve some mobile stations (which include the UE 105) within a serving area or region (e.g., a cell or a cell sector). In some embodiments, the TRP 103-1, the TRP 103-2, and the TRP 103-N may serve different UEs. The TRPs can communicate with each other via, for example, a backhaul link (not shown in FIG. 1).

The UE 105 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE 105 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE 105 may include wearable devices, such as smart watches, fitness bands, optical head-mounted displays, or the like. Moreover, the UE 105 may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present application, the TRPs, for example, the TRP 103-1, the TRP 103-2, . . . , the TRP 103-N may perform CJT with the UE 105. All the TRPs involved in the CJT may have the same antenna configuration but are at different locations. In the CJT, each TRP may transmit the same data to the UE 105. Each TRP may be configured and transmit with a CSI-RS resource for channel measurement with the same number of antenna ports. In other words, one TRP may correspond to one CSI-RS resource. Therefore, in the present disclosure, the expressions “per TRP” and “per CSI-RS resource” may be used interchangeable, the expressions “across TRPs” and “across CSI-RS resources” may be used interchangeable, or the like.

For Rel.16 enhanced type-II codebook, the codebook configuration and CSI reporting scheme associated with one TRP are specified in 3GPP documents, such as TS38.214.

Specifically, the codebook configuration may include a parameter (e.g., n1-n2-codebookSubsetRestriction-r16) that indicates a codebook subset restriction for a number pair consisting of N₁ and N₂. The supported configurations of (N₁, N₂) for a given number of CSI-RS ports and the corresponding values of (O₁, O₂) are described in Table 5.2.2.2.1-2 in TS38.214, and the number of CSI-RS ports, P_{CSI-RS}, is 2N₁N₂. Table 5.2.2.2.1-2 in TS38.214 is reproduced below.

TABLE 5.2.2.2.1-2
Supported configurations of (N₁, N₂) and (O₁, O₂)

| Number of CSI-RS | | |
|---|---|---|
| antenna ports, P_{CSI-RS} | (N₁, N₂) | (O₁, O₂) |
| 4 | (2, 1) | (4, 1) |
| 8 | (2, 2) | (4, 4) |
| | (4, 1) | (4, 1) |
| 12 | (3, 2) | (4, 4) |
| | (6, 1) | (4, 1) |
| 16 | (4, 2) | (4, 4) |
| | (8, 1) | (4, 1) |
| 24 | (4, 3) | (4, 4) |
| | (6, 2) | (4, 4) |
| | (12, 1) | (4, 1) |
| 32 | (4, 4) | (4, 4) |
| | (8, 2) | (4, 4) |
| | (16, 1) | (4, 1) |

The codebook configuration may also include a parameter (e.g., paramCombination-r16) indicating a combination consisting of a number of selected beams (represented as L) for a TRP, a factor (represented as β), and a frequency compression ratio (represented as p_{ν}). The values of the parameter are described in Table 5.2.2.2.5-1 in TS 38.214, which is reproduced below.

TABLE 5.2.2.2.5-1
Codebook parameter configurations for L, β and p_{υ}

| | | p_{υ} | | |
|---|---|---|---|---|
| paramCombination-r16 | L | υ ∈ {1, 2} | υ ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

In the above table, the parameter ν may indicate the rank indication (RI) value. The UE may report the RI value ν according to the configured higher layer parameter typeII-RI-Restriction-r16. The UE may not report the RI value in the case that ν>4.

The UE may determine a CSI report based on the above parameters, e.g., n1-n2-codebookSubsetRestriction-r16 and paramCombination-r16.

Furthermore, the CSI report may include a number of nonzero coefficients. For one TRP, a value K₀ may be used to define a maximum non-zero coefficient per layer, and 2K₀ is used to define the maximum total number of non-zero coefficients across layers of the TRP.

The value K₀ may be calculated as follows:

$${K}_{0} = ⌈ β 2 L {M}_{1} ⌉ .$$

wherein β and L are defined as described above, and M₁ is a number of bases in a frequency domain.

The bitmap whose nonzero bits identify which coefficients in an amplitude coefficient indicator i_{2,4,l} and a phase coefficient indicator i_{2,5,l} are reported, is indicated by i_{1,7,l} as follows:

$${i}_{1 , 7 , l} = [ {k}_{l , 0}^{( 3 )} … {k}_{l , {M}_{v} - 1}^{( 3 )} ]$$

$${k}_{l , f}^{( 3 )} = [ {k}_{l , 0 , f}^{( 3 )} … {k}_{l , 2 L - 1 , f}^{( 3 )} ]$$

$${k}_{l , i , f}^{( 3 )} ∈ \{ 0 , 1 \}$$

for l=1, . . . , ν, such that

$${K}_{l}^{NZ} = {\sum }_{i = 0}^{2 L - 1} {\sum }_{f = 0}^{{M}_{v} - 1} {k}_{l , i , f}^{( 3 )} \leq {K}_{0}$$

is the number of nonzero coefficients for layer l=1, . . . , ν and

$${K}^{NZ} = {\sum }_{l = 1}^{v} {K}_{l}^{NZ} \leq 2 {K}_{0}$$

is the total number of nonzero coefficients.

The detailed bitmap information regarding the nonzero coefficients is described in 3GPP documents, such as TS 38.214, and details are omitted here.

In view of the above, for Rel.16 e-Type-II codebook, the codebook configuration and maximum number of non-zero coefficients are designed based on single TRP (S-TRP) transmission.

Currently, it is agreed to specify enhancements of CSI acquisition for CJT targeting FR1 and up to 4 TRPs, assuming ideal backhaul and synchronization as well as the same number of antenna ports across TRPs. Some agreements are presented as follow:
Rel-16/17 Type-II codebook refinement for CJT multiple TRP (mTRP) targeting FDD and its associated CSI reporting, taking into account throughput-overhead trade-off:
SRS enhancement to manage inter-TRP cross-SRS interference targeting TDD CJT via SRS capacity enhancement and/or interference randomization, with the constraints that 1) without consuming additional resources for SRS: 2) reuse existing SRS comb structure: 3) without new SRS root sequences:
Note: the maximum number of CSI-RS ports per resource remains the same as in Rel-17, i.e. 32;
For the Rel-18 Type-II codebook refinement for CJT mTRP with N_{TRP}>1 TRP or TRP-groups, support N_{TRP}={1, 2, 3, 4} with equal priority;
For the Rel-18 Type-II codebook for CJT mTRP, support RI={1, 2, 3, 4};
For the Rel-18 Type-II codebook refinement for CJT mTRP with N_{TRP}>1 TRP/TRP-groups, the following is supported:
   The channel measurement resource (CMR) comprises K>1 NZP CSI-RS resources, where one resource corresponds to one TRP/TRP-group (i.e. K=N_{TRP}).
   Each of the CSI-RS resources has the same number of CSI-RS ports;
For the Rel-18 Type-II codebook for CJT mTRP, support the following two modes:
   Mode 1: Per-TRP/TRP-group SD/FD basis selection which allows independent FD basis selection across N TRPs/TRP groups. Example formulation (N=number of TRPs or TRP groups) may be as follows:

$$[ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ]$$

Mode 2: Per-TRP/TRP group (port-group or resource) SD basis selection and joint/common (across N TRPs) FD basis selection. Example formulation (N=number of TRPs or TRP groups) may be as follows:

$$[ \begin{matrix}{W}_{1 , 1} {\tilde{W}}_{2 , 1} {W}_{f}^{H} \\ ⋮ \\ {W}_{1 , N} {\tilde{W}}_{2 , N} {W}_{f}^{H}\end{matrix} ]$$

Striving for the two modes to share commonality in detailed designs such as parameter combinations, basis selection, TRP (group) selection, reference amplitude, W₂ quantization schemes.

In view of the above, in Rel.18, CJT may be further studied, where the same information may be coherently transmitted from multiple TRPs. However, there is no codebook configuration for CJT multiple TRPs, thus it is desirable for the codebook configuration for CJT multiple TRPs. Furthermore, the parameter combination and the total number of non-zero coefficients should be further considered to balance between the CSI overhead and system performance, especially in the case of a large TRP number (e.g. 4 TRPs) and a maximum RI value (e.g. 4).

For CJT, an enhanced codebook is designed for CSI reporting including multiple TRPs. Two codebook structures are agreed to be supported in Rel. 18, which are presented as follows:
Mode 1: per TRP or TRP-group spatial domain and frequency domain basis independent selection scheme across N TRPs or TRP groups are used, where N may be an integer equal to or larger than two.
Mode 2: per TRP or TRP group spatial domain selection and joint or common frequency domain basis selection across N TRPs are used, where N may be an integer equal to or larger than two.

Therefore, the codebook configuration and restriction should be aligned with these two agreed codebook structures.

The present disclosure proposes some solutions related with the codebook configuration and restriction. In particular, the present disclosure proposes a codebook configuration on a rank restriction (e.g., typeII-RI-Restriction-r18), values for N₁ and N₂, a codebook subset restriction (e.g., n1-n2-codebookSubsetRestriction-r18), and per TRP and/or joint parameter combination (paramCombination-r18) (including detailed configurations for a number of selected beam L, a factor β, and a frequency compression ratio p_{ν}), and restrictions on the maximum non-zero coefficient number per TRP and the maximum non-zero coefficient number across TRPs for CJT.

The aforementioned two modes (i.e., codebook structures) may be configured in a radio resource control (RRC) signalling, which may be represented as codebookConfig-r18. For both mode 1 and mode 2, some parameters may be configured with one value or a common value and used for all TRPs for CJT, because the same information may be transmitted from all cooperative TRPs. In other words, all TRPs may apply the same parameters. These parameters may include:
a rank restriction, which may be referred to as typeII-RI-Restriction-r18:
a number of precoding matrix indicator (PMI) subbands for each channel quality indication (CQI) subband, which may be referred to as numberOfPMI-SubbandsPerCQI-Subband-r18; and
a number of antenna ports in a first dimension, and a number of antenna ports in a second dimension, which may be referred to as: N₁ and N₂, respectively.

### Solution 1:

The values of N₁ and N₂ may be configured in a codebook subset restriction for each TRP, for example, n1-n2-codebookSubsetRestriction-r18. The number of CSI-RS ports, P_{CSI-RS}, for each TRP may be: 2N₁N₂. The value of N₁ is associated with O₁, and the value of N₂ is associated with O₂. The values of N₁, N₂, O₁, and O₂, and P_{CSI-RS} are the same among the multiple TRPs to facilitate CJT based on agreement that each of the CSI-RS resources in the channel measurement resources (CMRs) has the same number of CSI-RS ports.

In some embodiments, the value of N₁ and N₂ pair corresponding to total CSI-RS antenna ports among all cooperative TRPs may be associated with the UE capability.

The UE may report its capability to the BS. The capability of the UE may include one of the following:
a supported maximum number of TRPs (i.e. CSI-RS resources as channel measurement resources), and a supported maximum number of CSI-RS ports per TRP (i.e. per CSI-RS resource); or
a supported maximum number of TRPs (i.e. CSI-RS resources as channel measurement resources), and a supported maximum number of CSI-RS ports across TRPs (i.e. across CSI-RS resources); or
a supported maximum number of CSI-RS ports across TRPs (i.e. across CSI-RS resources).

The supported maximum number of CSI-RS ports across TRPs for CJT may include one of: 8, 12, 16, 24, 32, 64, etc. Other numbers of CSI-RS ports may also be applied in some embodiments of the present disclosure. Different UEs may support different maximum numbers of CSI-RS ports for CJT. In some embodiments, a set of supported number of CSI-RS ports for CJT may be predefined in specification, and each UE may report one value from this set as the maximum number of CSI-RS ports for CJT. In some embodiments, the BS may configure a set of supported maximum number of CSI-RS ports for UEs, and each UE may report one value from this set. For example, the predefined or configured set may include at least one of 8, 12, 16, 24, 32, 64, etc.

The supported configurations of (N₁, N₂) and (O₁, O₂) for CJT are shown in Table 1 based on the UE capability, wherein it is assumed that the UE may support a maximum number of 32 CSI-RS antenna ports across TRPs, and a maximum number of 4 TRPs.

TABLE 1
supported configurations of (N₁, N₂) and (O₁, O₂) for CJT

| Number of | | | TRP number for |
|---|---|---|---|
| CSI-RS antenna | | | CJT (CSI-RS |
| ports per | | | resource number in |
| TRP, P_{CSI-RS} | (N₁, N₂) | (O₁, O₂) | the CMR) |
| 4 | (2, 1) | (4, 1) | 2, 3, or 4 |
| 8 | (2, 2) | (4, 4) | 2, 3, or 4 |
| | (4, 1) | (4, 1) | 2, 3, or 4 |
| 12 | (3, 2) | (4, 4) | 2 |
| | (6, 1) | (4, 1) | 2 |
| 16 | (4, 2) | (4, 4) | 2 |
| | (8, 1) | (4, 1) | 2 |

In the case that the number of CSI-RS antenna ports per TRP is 4 or 8, the supported TRP number for CJT may be 2, 3, or 4. In the case that the number of CSI-RS antenna ports per TRP is 12 or 16, the supported TRP number for CJT may be 2. In some embodiments, for example, more than 4 TRPs may be supported for CJT, and in the case that the number of CSI-RS antenna ports per TRP is 4, the supported TRP number for CJT may be 8.

It should be noted that Table 1 is just an example for illustrating, not for limiting; other configurations of supported configurations of (N₁, N₂) and (O₁, O₂) for CJT may also be applied.

In addition to the above-mentioned parameters that may be configured with one value (or common value) across TRPs, some other parameters may be configured with values for each TRP (i.e. per TRP) for codebook structure mode 1 and across TRPs (i.e. for 2 TRPs, 3 TRPs, 4 TRPs, etc.) for codebook structure mode 2.

For example, the codebook subset restriction (e.g. n1-n2-codebookSubsetRestriction-r18) may be configured per TRP for codebook structure mode 1 and across TRPs for codebook structure mode 2. The codebook subset restriction is defined per beam selected from one TRP and thus it is natural to make independent configuration between TRPs according to the requirement of the BS. For codebook structure mode 1, the codebook subset restriction may be configured independently for each TRP. For codebook structure mode 2, the codebook subset restriction may be configured for a combination of beams from multiple cooperative TRPs. From signalling view, both of them can be implemented with multiple n1-n2-codebookSubsetRestriction-r18 restriction bit strings with one n1-n2-codebookSubsetRestriction-r18 corresponding one cooperative TRP for CJT.

### Solution 2:

Solution 2 relates to a parameter combination (e.g. paramCombination-r18) included in the codebook configuration. The parameter combination may consist of the following parameters:
a number of selected beams, which may be referred to as L;
a factor, which may be referred to as β; and
a frequency compression ratio, which may be referred to as pᵥ.

Some parameters in the codebook parameter combination may be configured per TRP since the RSRPs and signal strengths of the TRPs may have some differences and thus the corresponding feedback overheads may be different.

The present disclosure proposes some solutions for configuring the codebook parameter combination. Hereinafter, the codebook parameter combination may be referred to as “paramCombination-r18” for simplicity, but not for limiting.

### Solution 2-1

In this solution, the parameter combination (L, β, p_{ν}) may be configured for each TRP (i.e. per TRP paramCombination-r18) separately, that is, each TRP may be configured with one parameter combination (L, β, p_{ν}) based on codebook structure mode 1.

The RRC signaling for codebook configuration, e.g. codebookConfig-r18, may include multiple parameter combinations, paramCombination-r18, wherein each paramCombination-r18 may correspond to one TRP. There is an implicit one to one mapping between one NZP CSI-RS resource (i.e. resourcesForChannelMeasurement) and one parameter combination (i.e. paramCombination-r18). In other words, each parameter combination may correspond to one NZP CSI-RS resource, i.e. each parameter combination may correspond to one TRP.

In some embodiments, in the case that codebook structure mode 1 is configured in the RRC signalling, and only one parameter combination paramCombination-r18 is included in the RRC signalling, the same parameter combination configuration paramCombination-r18 may apply to each TRP for CJT, i.e. each TRP may be associated with the same paramCombination-r18.

In some embodiments of the present disclosure, it is proposed that for each TRP, the number of selected beams, i.e. L, may be smaller than 6, because a relatively large number of L may cause a relatively large number of reporting overhead in case of a large TRP number but it may not bring remarkable performance gain on account of restricted total CSI-RS port number.

For the factor, it is proposed that a smaller value (e.g. less than ¼, for example, ⅛, 1/16, or the like) may be configured to reduce CSI overhead in case of a relatively larger TRP number (for example, 3 TRPs, or 4 TRPs, etc.) and a higher rank value (e.g. 3 or 4).

In some embodiments of the present disclosure, it is proposed that CSI reporting overhead in case of 3 or 4 TRPs is no more than a maximum overhead in case of 2 TRPs.

Table 2a depicts an example for separate codebook parameter configurations paramCombination-r18 (i.e., per TRP) for CJT.

TABLE 2a
Separate codebook parameter configurations
for L, β and p_{υ} for CJT

| paramCombi- | | p_{υ} | | |
|---|---|---|---|---|
| nation-r18 | L | υ ∈ {1, 2} | υ ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 2 | ¼ | ⅛ | ⅛ in case of |
| | | | | TRP number > 2 |
| 8 | 4 | ¼ | ⅛ | ⅛ in case of |
| | | | | TRP number > 2 |

In Table 2a, the numbers of selected beams, i.e. L, are all smaller than 6. The factor β with a smaller value is configured in case of more than 2 TRPs. For example, in the case that the value of paramCombination-r18 is 7, the value of the factor β is ⅛ in the case that there are more than 2 TRPs, for example, 3 TRPs, or 4 TRPs, and the value of L is 2. In the case that the value of paramCombination-r18 is 8, the value of β is ⅛ in the case that there are more than 2 TRPs, for example, 3 TRPs, or 4 TRPs, and the value of L is 4.

It should be noted that Table 2a is just an example for illustrating, not for limiting; other configurations of the parameter combination may also be applied.

### Solution 2-2

In this solution, one parameter combination (L, β, p_{ν}) may be configured for all TRPs based on codebook structure mode 2. That is, a joint paramCombination-r18 is configured based on codebook structure mode 2.

The frequency compression ratio, i.e. p_{ν}, may be common for all TRPs.

The total selected beam number across TRPs, L, may be configured in joint paramCombination-r18. It is supposed that there are N TRPs, and the number of selected beam for TRP n is Lₙ, then

$$L = {\sum }_{n = 1}^{N} {L}_{n} .$$

In the case of 3 TRPs, 4 TRPs or more, a relatively larger

$$L = {\sum }_{n = 1}^{N} {L}_{n}$$

may be configured to support 2 selected beams per TRP, for example, L may be 6, 8, or even more. In addition, a smaller value of L, such as 2, may be not so useful since there are at least two TRPs for CJT.

For β, a smaller value (e.g. less than ¼, for example, ⅛, 1/16, or the like) may be configured to reduce CSI overhead in the case that there are 3 TRPs, 4 TRPs, or even more TRPs, and in the case that the rank value may be 3, 4, or even higher.

In some embodiments, the CSI reporting overhead in the case that there are 3 or 4 TRPs may be no more than the maximum overhead associated with two TRPs. Table 2b illustrates an example for joint paramCombination-r18 for CJT.

TABLE 2b
Joint codebook parameter configurations for L, β and p_{υ} for CJT

| paramCombi- | | p_{υ} | | |
|---|---|---|---|---|
| nation-r18 | L | υ ∈ {1, 2} | υ ∈ {3, 4} | β |
| 1 | 4 | ¼ | ⅛ | ¼ |
| 2 | 4 | ¼ | ⅛ | ½ |
| 3 | 4 | ¼ | ¼ | ¾ |
| 4 | 4 | ½ | ¼ | ½ |
| 5 | 6 | ¼ | ⅛ | ¼ |
| 6 | 6 | ¼ | ⅛ | ½ |
| 7 | 8 | ¼ | ⅛ | ¼ |
| 8 | 8 | ¼ | ⅛ | ½ |
| 9 | 4 | ¼ | ⅛ | ⅛ in case of |
| | | | | TRP number > 2 |
| 10 | 6 | ¼ | ⅛ | ⅛ in case of |
| | | | | TRP number > 2 |
| 11 | 8 | ¼ | ⅛ | ⅛ in case of |
| | | | | TRP number > 2 |

As explained above, the value of the selected beam number (i.e. L) may not be 2 for joint codebook parameter configurations. In the case that the value of paramCombination-r18 is 5, 6, or 10, which corresponds to the value of L being 6, 3 TRPs CJT may be supported with the number of selected beams for each TRP being 2. In the case that the value of paramCombination-r18 is 7, 8, or 11, which corresponds to the value of L being 8, 4 TRPs CJT may be supported with the number of selected beams for each TRP being 2. In some other embodiments, the number of selected beams across TRPs may include 4, 5, 6, 7, 8, 9, etc.

In the case that the values of paramCombination-r18 is 9, 10, or 11, the value of the factor β may be ⅛, which is smaller compared with other values of β, and the smaller value of β may be used for a higher rank and/or larger TRP number for CJT.

It should be noted that Table 2b is just an example for illustrating, not for limiting; other configurations of the parameter combination may also be applied.

For this solution, the parameter combination (L, β, p_{ν}) may be defined from view of multiple TRPs. If the same configuration on L, β, p_{ν} is restricted for each TRP, the proposed configuration also can be defined from each TRP's perspective. For example, the same value of β, p_{ν} may be used for configuration defined across TRPs and configuration defined per TRP. The value of the selected beams across TRPs (which may be represented as L′) may be equal to a product of a total number of TRPs (which may be represented as N) for CJT and the value of L defined per TRP, i.e. L′=N×L.

### Solution 3

Solution 3 relates to restriction on the maximum non-zero coefficient number per TRP and the maximum non-zero coefficient number across TRPs.

The CSI report may include a number of non-zero coefficients. The number of the non-zero coefficients may be restricted by the following two parameters:
i. a maximum number of non-zero coefficients per layer, and
ii. a maximum number of non-zero coefficients across layers (i.e., a maximum total number of non-zero coefficients).

That is, the number of non-zero coefficients for each layer may not exceed the first parameter, i.e. the maximum number of non-zero coefficients per layer; and the total number of non-zero coefficients may not exceed the second parameter, i.e., the maximum number of non-zero coefficient across layers.

For codebook structure mode 1, for each TRP, the parameter K₀ is used to define the maximum number of non-zero coefficients per layer, and 2K₀ is used to define the maximum number of non-zero coefficients across layers. The parameter K₀ is calculated as follows:

$${K}_{0} = ⌈ β 2 {LM}_{1} ⌉$$

where β is a factor, L is a number of selected beams, M₁ is a number of bases in a frequency domain, and these parameters are configured per TRP in the codebook configuration.

With the above restrictions, i.e. K₀ as the maximum number of non-zero coefficients per layer and 2K₀ as the maximum number of non-zero coefficients across layers for one TRP, it avoids too many non-zero coefficients for one TRP, e.g. one TRP with a larger RSRP value compared with other TRP(s).

Regarding the total number of non-zero coefficients across TRPs, in order to balance between CSI reporting overhead and system performance, for high rank (for example, the rank may be 3, 4, or even higher) transmission, the CSI reporting overhead may be the same as that for rank 2. That is, in the case that the same value of K₀ is determined for each TRP, the maximum number of non-zero coefficients per layer across TRPs (for example, 3 TRPs, 4 TRPs, or even more TRPs) is 2 Kg, and the maximum number of non-zero coefficients across layers across TRPs (for example, 3 TRPs, 4 TRPs, or even more TRPs) is 4K₀.

In some embodiments, a coefficient x_k1 may be configured by the BS or predefined in specification. In the case that the same value of K₀ is determined for each TRP, the maximum number of non-zero coefficients per layer cross TRPs may be defined to be x_k1×K₀, and the maximum number of non-zero coefficients across layers across TRPs may be defined to be x_k1×2K₀. The value of x_k1 may include 2, 3, or other numbers.

In some other embodiments, different TRPs may have different values of K₀. For example, the parameters (i.e. β, L, or M₁) may be configured with different values for different TRPs. In this case,

$${K}_{0}^{′}$$

may be determined based on an the K₀ values of the TRPs. For example,

$${K}_{0}^{′}$$

may be a maximum, an average, or a minimum of all the K₀ values, a randomly selected value of K₀ among TRPs, etc. Then, the maximum number of non-zero coefficients per layer across TRPs may be determined to be

$$x\_k1 \times {K}_{0}^{′} ,$$

and the maximum number of non-zero coefficients across layers across TRPs may be determined to be

$$2 x\_k1 \times {K}_{0}^{′} .$$

In this way, the CSI reporting overhead is not linearly increased with the TRP number. For some TRPs with smallest RSRP values, a smaller number of non-zero coefficients can be reported.

For codebook structure mode 2 used for CJT, the parameters β, L, and M₁ may be defined for joint codebook across multiple TRPs. For example,

$$L = {\sum }_{n = 1}^{N} {L}_{n} ,$$

where L is the selected beam number for all TRPs, Lₙ is the selected beam number for one TRP (i.e., TRP n), and N is the total number of TRPs.

It is supposed that the selected beam number for each TRP is identical. Thus, for each TRP, the number of selected beams may be L/N. Then, the maximum number of non-zero coefficients per layer per TRP may be defined to be K₀=┌β2LM₁/N┐, and the maximum number of non-zero coefficients across layer per TRP may be defined to be 2 Kg.

Similarly, the maximum number of non-zero coefficients per layer across TRPs may be defined to be K₀=┌β2LM₁┐, and the maximum number of non-zero coefficients across layers across TRPs may be defined to be 2 Kg.

It should be noted that the parameter β in solution 3 may use the value as defined in solution 2, for example, ⅛ may be used for more than 2 TRPs.

FIG. 2 illustrates a flowchart of an exemplary method performed by a UE for CSI reporting according to some embodiments of the present disclosure. It is contemplated that the method may be performed by other devices with similar functions.

In operation 201, the UE may receive a codebook configuration for CSI reporting associated with a plurality of CSI-RS resources. In operation 202, the UE may transmit a CSI report based on the codebook configuration. The codebook configurations and restrictions on the maximum non-zero coefficient number per TRP and across TRP as described in any of the above embodiments may apply.

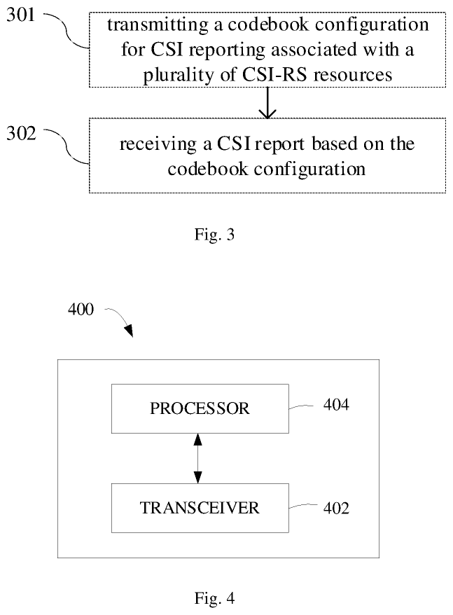

FIG. 3 illustrates a flowchart of an exemplary method performed by a BS for CSI reporting according to some embodiments of the present disclosure. It is contemplated that the method may be performed by other devices with similar functions.

In operation 301, the BS may transmit a codebook configuration for CSI reporting associated with a plurality of CSI-RS resources. In operation 302, the BS may receive a CSI report based on the codebook configuration. The codebook configurations and restrictions on the maximum non-zero coefficient number per TRP and across TRP as described in any of the above embodiments may apply.

In some embodiments, the codebook configuration includes at least one first parameter (e.g. n1-n2-codebookSubsetRestriction-r18), and each first parameter indicates a codebook subset restriction for a number pair (e.g. N₁ and N₂) consisting of: a first number of antenna ports in a first dimension (e.g. N₁); and a second number of antenna ports in a second dimension (e.g. N₂); wherein each of the at least one first parameter is associated with one of the plurality of CSI-RS resources; or wherein in the case that only one first parameter is included in the codebook configuration, the first parameter is associated with the plurality of CSI-RS resources.

In some embodiments, restricted values of the first number and the second number included in the codebook subset restriction are determined based on a total number of the plurality of CSI-RS resources, a capability of the UE, or both.

In some embodiments, the transceiver further transmits a capability of the UE to the BS, wherein the capability of the UE includes one of the following: a supported maximum number of CSI-RS resources as channel measurement resources and a supported maximum number of CSI-RS ports per CSI-RS resource; the supported maximum number of CSI-RS resources as channel measurement resources and a supported maximum number of CSI-RS ports across CSI-RS resources; or the supported maximum number of CSI-RS ports across CSI-RS resources.

In some embodiments, the supported maximum number of CSI-RS ports across CSI-RS resources includes a value selected from a set including at least one of 8, 12, 16, 24, 32, or 64. In some embodiments, the set may include other numbers

In some embodiments, the codebook configuration further indicates a same pair of values of the number pair for each of the plurality of CSI-RS resources.

In some embodiments, the codebook configuration includes at least one second parameter, and each second parameter indicates a combination consisting of: a number of selected beams L; a factor β; and a frequency compression ratio p_{ν}; wherein each of the at least one second parameter is associated with one of the plurality of CSI-RS resources; or wherein in the case that only one second parameter is included in the codebook configuration, the second parameter is associated with the plurality of CSI-RS resources.

In some embodiments, the number of selected beams is 2 or 4 in the case that the number of selected beams is configured per CSI-RS resource (for example, in Table 2a, the number of selected beams, i.e. L, is 2 or 4), or is 4, 5, 6, 7, or 8 in the case that the number of selected beams is configured across the plurality of CSI-RS resources (for example, in Table 2b, the number of selected beams, i.e. L, is 4, 6, or 8).

In some embodiments, the factor is a value smaller than ¼ in the case that more than two CSI-RS resources are included in the plurality of CSI-RS resources (for example, in Table 2b, the factor may have a value of ⅛).

In some embodiments, the CSI report includes a number of non-zero coefficients, and the UE determines at least one of the following based on the codebook configuration: a maximum number of non-zero coefficients per layer per CSI-RS resource; a maximum number of non-zero coefficients across layers per CSI-RS resource; a maximum number of non-zero coefficients per layer across CSI-RS resources; or a maximum number of non-zero coefficients across layers across CSI-RS resources.

In some embodiments, in the case that a factor β, a number of selected beams L, and a number of bases in a frequency domain M₁ are configured per CSI-RS resource in the codebook configuration (e.g., for codebook structure mode 1), the maximum number of non-zero coefficients per layer per CSI-RS resource is determined to be K₀=┌β2LM₁┐, and the maximum number of non-zero coefficients across layers per CSI-RS resource is determined to be 2K₀.

In some embodiments, in the case that a factor β, a number of selected beams L, and a number of bases in a frequency domain M₁ are configured across CSI-RS resources in the codebook configuration (e.g., for codebook structure mode 2), the maximum number of non-zero coefficients per layer per CSI-RS resource is determined to be K₀=┌β2LM₁/N┐, and the maximum number of non-zero coefficients across layers per CSI-RS resource is determined to be 2 Kg, wherein N is a total number of the plurality of CSI-RS resources.

In some embodiments, in the case that a factor β, a number of selected beams L, and a number of bases in a frequency domain M₁ are configured per CSI-RS resource in the codebook configuration (e.g., for codebook structure mode 1), for each CSI-RS resource, the UE determines a value K₀=┌β2LM₁┐, the maximum number of non-zero coefficients per layer across CSI-RS resources is determined to be

$$x\_k1 \times {K}_{0}^{′} ,$$

and the maximum number of non-zero coefficients across layers across CSI-RS resources is determined to be

$$2 x\_k1 \times {K}_{0}^{′} ,$$

wherein x_k1 is a predefined coefficient or a configured coefficient, and

$${K}_{0}^{′}$$

is a maximum or an average of all the determined values K₀.

In some embodiments, in the case that a factor β, a number of selected beams L, and a number of bases in a frequency domain M₁ are configured across CSI-RS resources in the codebook configuration (e.g., for codebook structure mode 2), the maximum number of non-zero coefficients per layer across CSI-RS resources is determined to be K₀=┌β2LM₁┐, and the maximum number of non-zero coefficients across layers across CSI-RS resources is determined to be 2K₀.

In some embodiments, the codebook configuration further indicates a same rank restriction for each of the plurality of CSI-RS resources.

FIG. 4 illustrates a simplified block diagram of an exemplary apparatus 400 according to some embodiments of the present disclosure.

As shown in FIG. 4, an example of the apparatus 400 may include at least one processor 404 and at least one transceiver 402 coupled to the processor 404. The apparatus 400 may be a UE, a BS or any other device with similar functions.

Although in this figure, elements such as the at least one transceiver 402 and processor 404 are described in the singular, the plural is contemplated unless a limitation to the singular is explicitly stated. In some embodiments of the present disclosure, the transceiver 402 may be divided into two devices, such as a receiving circuitry and a transmitting circuitry. In some embodiments of the present disclosure, the apparatus 400 may further include an input device, a memory, and/or other components.

In some embodiments of the present disclosure, the apparatus 400 may be a UE. The transceiver 402 and the processor 404 may interact with each other so as to perform the operations of the UE as described with respect to any of FIGS. 1-3. For example, the transceiver 402 may receive a codebook configuration for CSI reporting associated with a plurality of CSI-RS resources, and transmit a CSI report based on the codebook configuration. As another example, the processor 404 may determines at least one of the following based on the codebook configuration: a maximum number of non-zero coefficients per layer per CSI-RS resource; a maximum number of non-zero coefficients across layers per CSI-RS resource; a maximum number of non-zero coefficients per layer across CSI-RS resources; or a maximum number of non-zero coefficients across layers across CSI-RS resources.

In some embodiments of the present disclosure, the apparatus 400 may be a BS. The transceiver 402 and the processor 404 may interact with each other so as to perform the operations of the BS as described with respect to any of FIGS. 1-3. For example, the transceiver 402 may transmit a codebook configuration for CSI reporting associated with a plurality of CSI-RS resources, and receive a CSI report based on the codebook configuration.

In some embodiments of the present disclosure, the apparatus 400 may further include at least one non-transitory computer-readable medium.

For example, in some embodiments of the present disclosure, the non-transitory computer-readable medium may have stored thereon computer-executable instructions to cause the processor 404 to implement the method with respect to the UE as described above. For example, the computer-executable instructions, when executed, may cause the processor 404 interacting with the transceiver 402 to perform the operations of the UE as described with respect to any of FIGS. 1-3.

In some embodiments of the present disclosure, the non-transitory computer-readable medium may have stored thereon computer-executable instructions to cause the processor 404 to implement the method with respect to the BS as described above. For example, the computer-executable instructions, when executed, may cause the processor 404 interacting with the transceiver 402 to perform the operations of the BS as described with respect to any of FIGS. 1-3.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE), comprising:
at least one memory; and
at least one processor coupled with the at least one memory and configured to cause the UE to:
receive a codebook configuration for channel state information (CSI) reporting associated with a plurality of channel state information reference signal (CSI-RS) resources; and
transmit a CSI report based on the codebook configuration.

2. The UE of claim 1, wherein the codebook configuration includes one or more parameters, and wherein each parameter of the one or more parameters indicates a codebook subset restriction for a number pair comprising:
a first number of antenna ports in a first dimension; and
a second number of antenna ports in a second dimension;
wherein each parameter is associated with one of the plurality of CSI-RS resources.

3. The UE of claim 2, wherein restricted values of the first number and the second number included in the codebook subset restriction are determined based on a total number of the plurality of CSI-RS resources, a capability of the UE, or both.

4. The UE of claim 1, wherein the at least one processor is configured to cause the UE to transmit a capability of the UE to a base station (BS), wherein the capability of the UE includes one of the following:
a supported maximum number of CSI-RS resources as channel measurement resources and a supported maximum number of CSI-RS ports per CSI-RS resource;
the supported maximum number of CSI-RS resources as channel measurement resources and a supported maximum number of CSI-RS ports across CSI-RS resources; or
the supported maximum number of CSI-RS ports across CSI-RS resources.

5. The UE of claim 4, wherein the supported maximum number of CSI-RS ports across CSI-RS resources includes a value selected from a set including at least one of 8, 12, 16, 24, 32, or 64.

6. The UE of claim 2, wherein the codebook configuration further indicates a same pair of values of the number pair for each of the plurality of CSI-RS resources.

7. The UE of claim 1, wherein the codebook configuration includes one or more parameters, and wherein each parameter of the one or more parameters indicates a combination comprising:
a number of selected beams L;
a factor β; and
a frequency compression ratio pv;
wherein each parameter is associated with one of the plurality of CSI-RS resources; or wherein, if one parameter is included in the codebook configuration, the one parameter is associated with the plurality of CSI-RS resources.

8. The UE of claim 7, wherein the number of selected beams is 2 or 4 if the number of selected beams is configured per CSI-RS resource, or is 4, 5, 6, 7, or 8.

9. The UE of claim 7, wherein the factor is a value smaller than ¼ if more than two CSI-RS resources are included in the plurality of CSI-RS resources.

10. The UE of claim 1, wherein the CSI report includes a number of non-zero coefficients, and the processor determines at least one of the following based on the codebook configuration:
a maximum number of non-zero coefficients per layer across CSI-RS resources; or
a maximum number of non-zero coefficients across layers across CSI-RS resources.

11. The UE of claim 10, wherein, if a factor β, a number of selected beams L, and a number of bases in a frequency domain M₁ are configured per CSI-RS resource in the codebook configuration,
the maximum number of non-zero coefficients per layer per CSI-RS resource is determined to be ┌β2LM₁┐, and the maximum number of non-zero coefficients across layers per CSI-RS resource is determined to be 2┌β2LM₁┐; and/or
for each CSI-RS resource, the processor determines a value K₀=┌β2LM₁┐, the maximum number of non-zero coefficients per layer across CSI-RS resources is determined to be
$${x}_{k 1} \times {K}_{0}^{′} ,$$
and the maximum number of non-zero coefficients across layers across CSI-RS resources is determined to be
$$2 {x}_{k 1} \times {K}_{0}^{′} ,$$
wherein xₖ₁ is a predefined coefficient or a configured coefficient, and
$${K}_{0}^{′}$$
average of all the determined values K₀.

12. The UE of claim 10, wherein, if a factor β, a number of selected beams L, and a number of bases in a frequency domain M₁ are configured across CSI-RS resources in the codebook configuration,
the maximum number of non-zero coefficients per layer across CSI-RS resources is determined to be K₀=┌β2LM₁┐, and the maximum number of non-zero coefficients across layers across CSI-RS resources is determined to be 2K₀.

13. The UE of claim 1, wherein the codebook configuration further indicates a same rank restriction for each of the plurality of CSI-RS resources.

14. A base station (BS), comprising:
at least one memory; and
at least one processor coupled with the at least one memory and configured to cause the base station to:
transmit a codebook configuration for channel state information (CSI) reporting associated with a plurality of channel state information-reference signal (CSI-RS) resources; and
receive a CSI report based on the codebook configuration.

15. A method performed by a user equipment (UE), the method comprising:
receiving a codebook configuration for channel state information (CSI) reporting associated with a plurality of channel state information-reference signal (CSI-RS) resources; and
transmitting a CSI report based on the codebook configuration.

16. A processor for wireless communication, comprising:
at least one controller coupled with at least one memory and configured to cause the processor to:
receive a codebook configuration for channel state information (CSI) reporting associated with a plurality of channel state information reference signal (CSI-RS) resources; and
transmit a CSI report based on the codebook configuration.

17. The processor of claim 16, wherein the codebook configuration includes one or more parameters, and wherein each parameter of the one or more parameters indicates a codebook subset restriction for a number pair comprising:
a first number of antenna ports in a first dimension; and
a second number of antenna ports in a second dimension;
wherein each parameter is associated with one of the plurality of CSI-RS resources.

18. The processor of claim 17, wherein restricted values of the first number and the second number included in the codebook subset restriction are determined based on a total number of the plurality of CSI-RS resources, a capability of the processor, or both.

19. The processor of claim 16, wherein the at least one controller is configured to cause the processor to transmit a capability of the processor to a base station (BS), wherein the capability of the processor includes one of the following:
a supported maximum number of CSI-RS resources as channel measurement resources and a supported maximum number of CSI-RS ports per CSI-RS resource;
the supported maximum number of CSI-RS resources as channel measurement resources and a supported maximum number of CSI-RS ports across CSI-RS resources; or
the supported maximum number of CSI-RS ports across CSI-RS resources.

20. The processor of claim 19, wherein the supported maximum number of CSI-RS ports across CSI-RS resources includes a value selected from a set including at least one of 8, 12, 16, 24, 32, or 64.
